(19) United States
(12) Patent Application Publication
(10) Pub. No.: US 2023/0008302 A1
(43) Pub. Date: Jan. 12, 2023

(54) DISTRIBUTED LEDGER FOR INSTANTANEOUS CONSENSUS OF A DIGITAL TWIN

(71) Applicant: Everything Blockchain Technology Corp., Jacksonville, FL (US)

(72) Inventor: Cedric Harris, Sugarland, TX (US)

(73) Assignee: Everything Blockchain Technology Corp., Jacksonville, FL (US)

(21) Appl. No.: 17/842,482

(22) Filed: Jun. 16, 2022

Related U.S. Application Data
(60) Provisional application No. 63/220,193, filed on Jul. 9, 2021.

(51) Int. Cl. G06Q 20/40

(52) U.S. Cl. CPC G06Q 20/401; G06Q 2220/00

(57) ABSTRACT

A method for processing transactions for a decentralized application of a computing system includes receiving a transaction having associated data by the computing system. The transaction is processed using an event actor architecture. A first block related to said transaction is received, wherein the first block includes a cryptographic signature. The transaction is cryptographically processed using a chain-of-events blockchain, wherein the chain-of-events blockchain includes a ledger of blocks cryptographically linked by events. The transaction is rejected if the transaction accesses a second block not linked to the first block in a correct chain-of-events.

This application claims priority to provisional application U.S. 63/220,193, filed Jul. 9, 2021, the entire contents of which are incorporated herein by reference.

### FIELD

The present disclosure relates generally to security, and more particularly to performance and security enhancements for blockchain systems using distributed ledgers.

### BACKGROUND

A blockchain is a continuously growing list of transactions, called blocks, which are linked and secured using cryptography. Each block typically contains a private key derived from a cryptographic hash linking it to a previous block, and transaction data. For use as a distributed ledger, a blockchain typically is managed by a peer-to-peer network collectively adhering to a protocol for validating new blocks through a unique mathematical artifact called a proof. Once recorded, the data in any given block cannot be altered retroactively without the alteration of all subsequent blocks, which requires collusion of the network majority.

Generalizing, a blockchain is a decentralized, distributed, and digital ledger that is used to record transactions across many computers so that the record cannot be altered retroactively without the alteration of all subsequent blocks and the collusion of the network. In a typical blockchain, blocks hold batches of valid transactions that are hashed and encoded into a data structure. In this structure, each block includes a private key derived from a cryptographic hash linking it to the prior block in the blockchain. The linked blocks form a chain. This iterative process confirms the integrity of the previous blocks, all the way back to the original genesis (or first) block.

Merkle Trees are used as a way of hashing numerous transactions into a single hash key through a process called mining. The process of mining requires a repetitive process to continually generate hashes to update a Merkle Tree, and a block holds batches of numerous transactions that are originally hashed in a Merkle Tree. Mining is seen as the architectural design flaw of the blockchain that presents scalability limitations. While not being bound by theory, it is possible to create a vast block that contains every transaction in a ledger, however doing so would impose additional scalability challenges that put the use of blockchain technology out of the realm of practical utility.

Another key component of blockchain technology is the ability to verify the legitimacy of hashed transaction data reliably and independently within a blockchain. Generating a proof allows hashed data to be anchored to a blockchain thereby proving whether it belongs to a blockchain or not. As with mining, the process of generating proofs is an intensive effort and relies upon a trusted third party accessed by way of, for example, remote procedure call (RPC) or internet generated application programming interface (WebAPI) requests which create external dependencies that introduce latency.

Blockchain technology started as the innovation that powered the “Bitcoin” cryptocurrency. However, cryptocurrency represents only one vertical for the use of blockchain technology. In recent years, blockchain technology has seen wider application in numerous industries such as finance, supply chain management, medical records management, and ransom ware. Mining and anchoring, although necessary, are highly inefficient processes. On a limited application the impact of not being scalable is negligible. However, blockchain technology in its current state is not suitable for widespread use.

What is needed is an architecture that solves scalability limitations without sacrificing the seminal components such as hashing of transaction data and mining for proofs.

### BRIEF DESCRIPTION OF THE DRAWINGS

FIG. 1 shows a conceptual diagram of how an event actor works;

FIG. 2 shows an illustration of the event architecture;

FIG. 3 shows an illustration of a series of events as part of the QueryChain architecture over a traditional Merkle Tree using the chain-of-events consensus algorithm; and

FIG. 4 shows a distributed computer system implementing a chain-of-events consensus algorithm on a Kubernetes cluster according to various embodiments disclosed herein.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

The present disclosure addresses performance and security problems inherent to existing blockchain architectures by alleviating the common and accepted approach to the mining of blockchain transactions through the introduction of a new atomic unit of compute called the “Event Actor”. The Event Actor is based on the use of a mathematically unique chain-of-events to form an instantaneous consensus that can be used to overcome the repetitive and intensive processing (mining) of proofs for a parent Merkle Tree associated with a specific blockchain transaction.

In various embodiments, a system is configured to process transaction verification operations for a decentralized application via an event actor design architecture, where the system is configured to receive a block related to at least one transaction, the block including a ledger reading set and cryptographic signature associated with at least one transaction to be authenticated. The system includes an event queue through which event-based communications occur instantaneously in a series of mathematically unique patterns over a distributed network system of stateful nodes that operate as a digital twin to blockchain blocks to alleviate blockchain mining latency.

In one aspect, the system is configured such that incoming web requests arrive over HTTP protocol and activate an indeterminant series of event actor microservices, whereby the event actor receives asynchronous event-based notifications to alleviate blockchain latency.

In a related aspect, the system is configured such that the traditional reliance on persistent storage is alleviated in favor of stateful event actors to maintain the blockchain ledger, whereby horizontal scaling of services is achieved by extending its Google Kubernetes cluster of nodes running containerized application images within a daemonset.

In one aspect, the architecture is configured in an event-based architecture based on the Command Query Request Segregation (CQRS) design pattern, in which incoming requests are streamed as an array of binary bytes transmitted over the Representational State Transfer (REST) protocol and translated into a series of events distributed over the Google Kubernetes cluster.

In another aspect, each private block key and parent Merkle Tree hash key of the block is persisted through the event actor, whereby a child event actor is linked to its parent Merkle Tree root, whereby as a new transaction is added to an existing Merkle Tree, an event is distributed between newly created child events and its parent Merkle Tree.

In a related aspect, the system is configured such that when a parent Merkle Tree receives an event of the of a newly added transaction, the parent Merkle Tree updates its corresponding Merkle Tree root hash key, whereby the updated Merkle Tree root hash key is not broadcast to any other sibling event actors because of previous private keys sharing a common public key used to keep all ledger blocks in sync.

In another aspect, the system is configured to create restrictions between event actors through zero trust security and discoverability through a unique chain-of-events to form a consensus herein referred to as the “Chain-of-events Consensus Algorithm”.

In one aspect, the system supports the OpenAPI protocol via the Swagger development tools from SmartBear Software of Somerville, Mass. for incoming requests.

In a related aspect, the system supports the OpenAPI protocol, and wherein the topology of the architecture is configured to be hosted either in the cloud or on a client's premise and incorporates a series of decentralized servers via proxy servers to distribute OpenAPI traffic across a cluster of daemonset event actors.

In another related aspect, the system supports the publisher/subscriber design pattern to accommodate persisted TCP/IP connections configured to persist a single bi-directional connection between a client and an event actor within a cluster for greater responsiveness.

In a further related aspect, each event actor node communicates with each other via asynchronous events over a persisted TCP/IP connection.

In various embodiments, a method of processing transactions for a decentralized application is disclosed, the method being implemented on a computing device includes an event actor architecture based on the CQRS design pattern, where the architecture is configured to receive a block related to at least one transaction, the block includes a cryptographic signature associated with the at least one transaction to be authenticated that is initiated through an external system communicating over an OpenAPI RESTful request.

In one aspect, incoming OpenAPI RESTful requests activate event actor microservices.

In another aspect, all dependencies on traditional persisted data storage are alleviated in favor of stateful event actors in real-time used to maintain the blockchain ledger, whereby horizontal scaling of services is achieved through extending the number of nodes onto the Google Kubernetes cluster.

In a related aspect, events are raised over the distributed cluster of nodes using binarily serialized data based on the MessagePack serialization protocol.

In another aspect, the CQRS design architecture of the event actors is used to make all block data indexable without the necessity of making multiple copies of the same data which makes the near-instantaneous retrieval of data over a distributed blockchain cluster attainable in a manner not attainable by traditional mining.

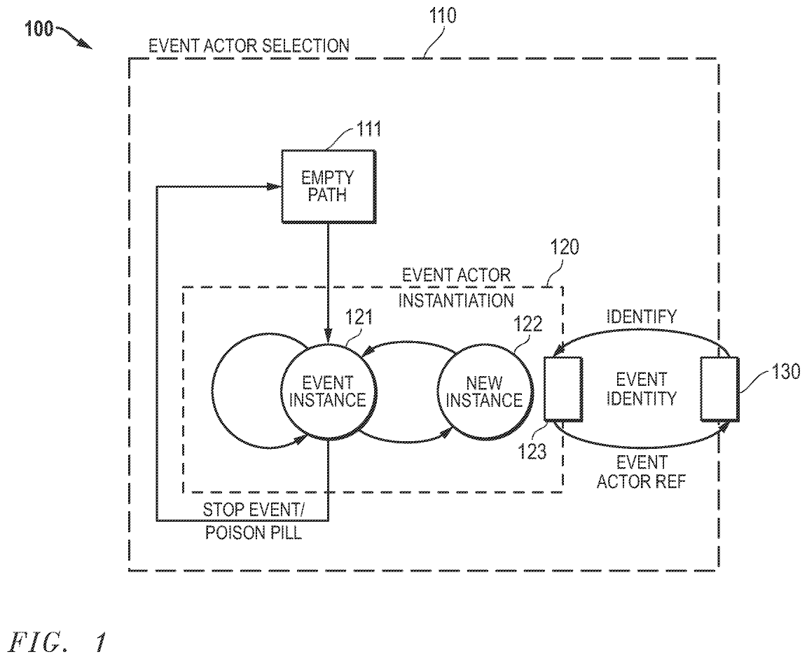

FIG. 1 shows a conceptual diagram 100 of how an event actor works using an event actor selection 110. Event actor selection 110 starts with an empty path 111, in which an event actor is assigned to a subject. A path is then reserved for that event actor, a random UID (unique identification) is assigned to an instantiation of the event actor, an instance is created, and a pre-start routine is called on the instance. An event actor instantiation 120 belongs to a particular path which has a UID and an event queue. A new instantiation replaces an old instantiation, and a post-restart function is assigned which calls on the new instantiation. After the new instantiation starts, a pre-restart function is called on the old instance. Once the event actor is identified in this manner, event actor selection 110 represents a path (or multiple paths with a wildcard) that allows for resolution of the underlying event actor reference by triggering an identify event between interfaces 130 and 123. The event reference represents the instantiation, in which the event reference has a path and UID, but hides it. A Stop event, or alternatively a Poison-Pill event, can be activated, depending on the instructions of the event, to allow the path to be used again.

The problem behind the inherent scalability barriers to blockchain technology is the architecture. More specifically, the root problem is the lack of a distributed architecture. The seminal objective of the blockchain technology was secure transactions through the immutability of its distributed ledgers, but scalability was not the primary objective.

Unsuccessful solutions to blockchain scalability have incorporated everything from Graphical Processing Unit (GPU) farms that use computationally intensive single instruction, multiple data (SIMD) processors, to large clusters of virtual machines (VMs). Various embodiments of the architecture disclosed herein use several design patterns for distributed computing to solve scalability challenges. This architecture is known as the “QueryChain” architecture.

Private or permissioned blockchain networks are far more secure than public blockchain networks. Private blockchain networks require a massive private cloud infrastructure to function at scale. According to some embodiments, the QueryChain architecture is coupled with a private cloud blockchain network based on the Kubernetes orchestration platform developed by Google, Inc. of Mountain View, Calif., to provide both a highly secure blockchain network with the performance of a public blockchain network. In various embodiments, the QueryChain architecture uses an event-based model based on the CQRS design pattern to make communications highly scalable. In some embodiments, a system using the QueryChain architecture receives external OpenAPI RESTful requests. However, internally, services communicate through an event architecture based on the CQRS design pattern at the microservices level. In a related aspect, this event actor architecture uses the faster protocol based on the Google remote procedure call (gRPC) protocol instead of the slower TCP/IP protocol.

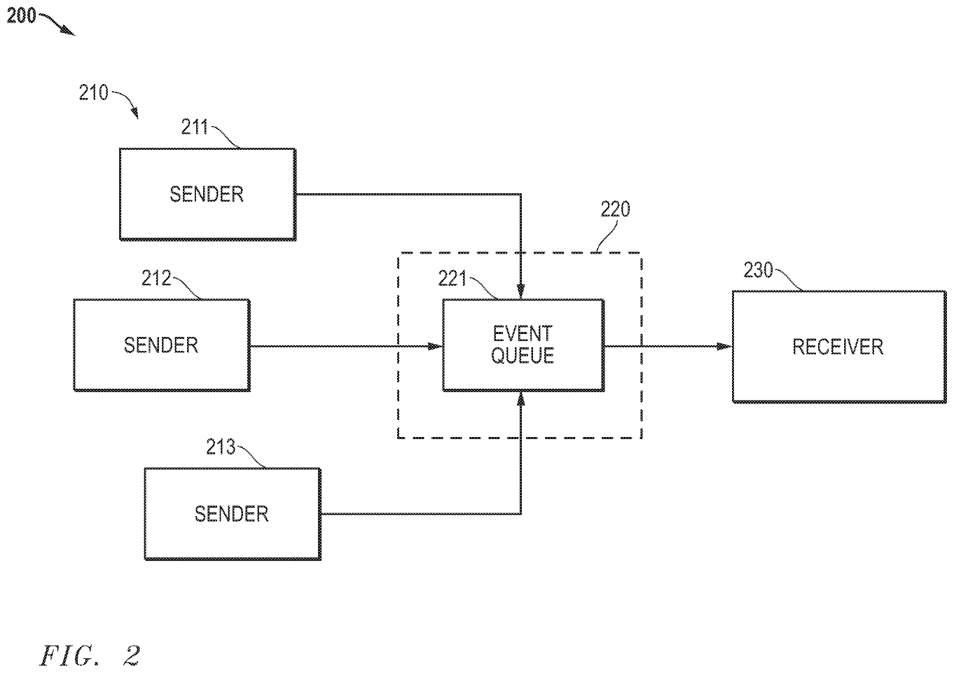

FIG. 2 illustrates a conceptual diagram 200 of the event architecture. In various embodiments, the QueryChain architecture uses the CQRS design pattern. Briefly, an event is triggered from one of a group of senders 210 such as exemplary senders 211, 212, and 213 to an event actor broker 220, in which the event enters an event queue 221 that routes and distributes incoming events that to the appropriate receiver 230. The data payload of an event envelope may include, but is not limited to, non-structured JSON (Java Script object notation), XML (extensible markup language), CSV (comma-separated values), JSV, SOAP (simple object access protocol), and Byte Arrays formats. In some embodiments, the internal serialization of the event payload uses the MessagePack serialization protocol, which is preferred to the Protocol Buffers serialization protocol which creates external dependencies that do not exist with the MessagePack serialization protocol.

Most blockchain solutions use numerous containerized service instances and/or GPUs to offload the process intensive work of mining and both creating and validating proofs. The architecture disclosed herein, however, uses an event actor architecture that may be based on the CQRS design pattern to create a digital twin of each blockchain transaction.

Event actors are primitive units of computation. A key advantage of event actors is that they are extremely fast due to not creating a context boundary between a sender and a receiver due to the need to wait for responses. Moreover, event actors are designed specifically for solving the problem of distributed computing as each event actor contains an event broker used in support of intra-service communications. Event actors are completely isolated and never share memory and are thereby stateful. The stateful aspect of event actors allows for each private key and parent Merkle Tree hash to be persistent and used to link the child event actor to its parent Merkle Tree root. As new transactions are added to an existing Merkle Tree, instantaneous events are brokered between the newly spawned children and its Merkle Tree digital twin. As a Merkle Tree digital twin receives events of newly added transactions, the Merkle Tree digital twin updates its Merkle Tree root hash key. In turn, this updated Merkle Tree root hash key does not need to rebroadcast to siblings due to the unique cryptographic signature keeping all previous private blockchain keys in synchronization. Thus, event actors represent a more powerful means of addressing scalability challenges than typical microservices considering that one can spawn more on a single box than a typical microservices. As disclosed herein, as event actors are spawned, the QueryChain architecture achieves greater density than relying on numerous containerized service instances and/or GPUs in the cloud.

Subtle vulnerabilities within the seemingly impervious blockchain cryptography have surfaced in recent years. These vulnerabilities arose through the online exchanges where cryptocurrency wallets are stored. In these instances, basic security to safeguard public and private keys would work. However, it is the more sophisticated 51% attack that was the most alarming. In the 51% attack hackers sought to achieve a majority of computing power to control the mining effort that proofs depend on. Simply put, if one gains a majority (51%) of the node computing power in a network then one needs to establish a consensus needed to establish what transactions will become accepted by the minority (49%) of the nodes. The architecture as disclosed herein is based on the “Raft” consensus algorithm not to agree on transactions, but on the existence and location of node actors within its cluster. By restricting the use of consensus algorithms to actors, node discoverability transactions are never made vulnerable to brute force denial of service attacks such as 51%.

The chain-of-events consensus algorithm described herein addresses the fundamental performance and security issues surrounding blockchain. The fundamental performance issues common to blockchain is its inability to scale. Currently, blockchain can only process a maximum of 15 contracts per minute. This makes widespread adoption of blockchain difficult, at best.

As disclosed herein, the event actor architecture may be based on the CQRS design pattern. The event actor architecture is used to provide stateful microservices that are highly scalable and responsive to streaming events. Instead of constantly iterating over blocks in a process intensive manner (a process known as “mining for blockchain contracts”), the architecture as disclosed herein utilizes the event actor architecture to define a unique chain-of-events create an instantaneous consensus of the location and validity of any block of data in a ledger.

The event actor architecture is an event-based approach used to facilitate a highly scalable system of stateful yet immutable nodes to operate as a digital twin of blockchain blocks associated with transactional data. The event actor architecture alleviates excessive latency common to of the traditional process intensive mining of blockchain that is based on messaging.

In some embodiments, a plugin module is used to create a unique digital signature based on the heuristics of the user's system behavior combined with the blockchain private keys. This heuristic-based security mechanism allows the event actor architecture to detect anomalies that trigger multifactor authentication in the form of email communications to guard against ransomware and identity theft attacks, before access to sensitive blockchain data is granted.

In various embodiments, plugin modules utilize blockchain smart contracts to perform process automation through the event actor architecture based on the CQRS design pattern. In a related aspect, these modules utilize blockchain to provide automation of tasks through a smart contract scripting language that is added to the blockchain ledger as a specialized block that is run autonomously against every newly added block to the ledger. In another instance, the automation can create new blockchain ledgers and create calculated fields that retain state even in a disaster recovery scenario.

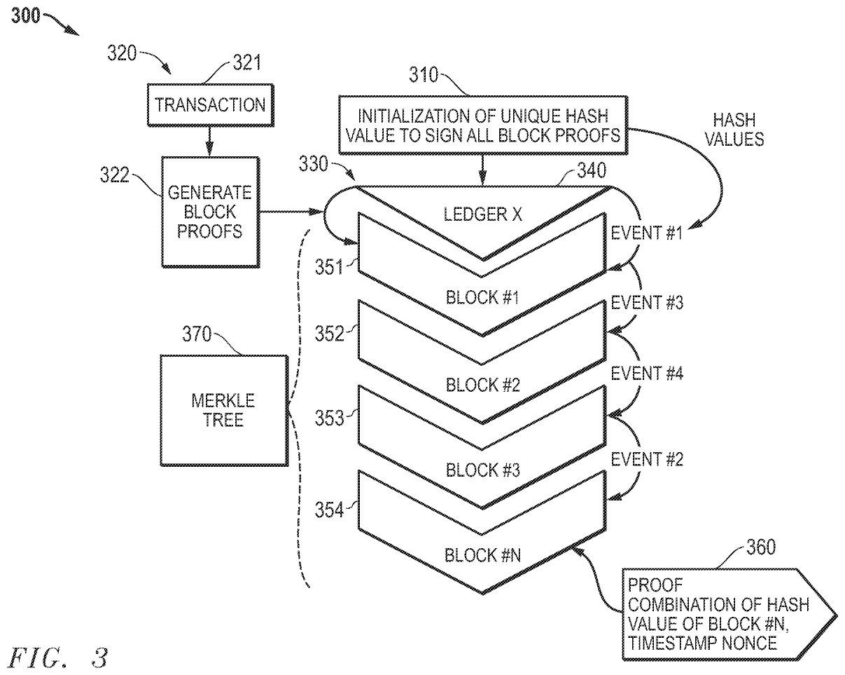

FIG. 3 shows an illustration of a flow 300 of a series of events as part of the QueryChain architecture over a traditional Merkle Tree using the chain-of-events consensus algorithm. Flow 300 starts with a box 310 in which the distributed computer system initializes a unique hash value that it will use to sign all block proofs in the blockchain. A transaction is added by boxes 320, in which in a box 321 the computer system receives a transaction, and in a box 322 the computer system generates block proofs for the transaction. A blockchain 330 includes a ledger 340 and an exemplary set of blocks 351-354 that are cryptographically linked in a growing chain-of-events. For example, the first transaction adds a block 351 labelled “BLOCK #1” to the blockchain by hashing its data and recording it in ledger 340. The computer system performs this pattern to add a series of blocks labelled “BLOCK #2”, “BLOCK #3”, and so on until a last block labelled “BLOCK #N” to the blockchain.

However, the events do not follow the sequential order of blocks in the ledger. For example, BLOCK #2 is tied to EVENT #3, BLOCK #3 is tied to EVENT #4, and so on until a last block, Block #N, is tied to EVENT #2. The chain-of-events for each block of data is mathematically unique. Each block uses zero-trust security to maintain affinity to the previous block within the chain-of-events. If an event triggers a communication with a block not tied to the proper chain-of-events, then the block rejects the communication with it, and access to its block data is denied. The location of any single block within ledger 340 is based on a unique combination of event patterns similar to that of a combination to a lock, or to the firing of synapses in the brain. A computer system implementing the chain-of-events consensus algorithm leverages the randomness of the chain-of-events in receiving and distributing the event actors among the compute nodes in the system to reject malicious communications that attempt to access the data in the system.

Flow 300 also creates a Merkle Tree 370 to maintain proofs for each block within the ledger. For example, as shown in box 360, the proof for Block #N is the combination of the hash value for Block #N and a timestamp nonce.

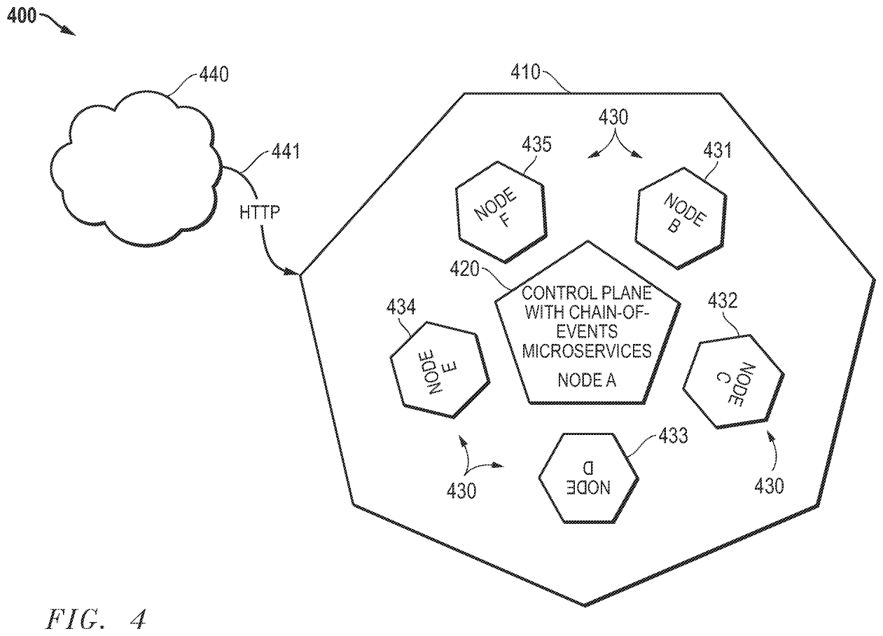

FIG. 4 shows a distributed computer system 400 implementing a chain-of-events consensus algorithm on a Kubernetes cluster 410 according to various embodiments disclosed herein. In some embodiments, Kubernetes cluster 410 includes multiple remote nodes that communicate with each other securely over public or private networks. In other embodiments, Kubernetes cluster 410 includes nodes that are co-located in a multi-node computer system, server, server farm, etc. that communication with each other over private networks.

Kubernetes cluster 410 includes a control plane 420 which is designated “Node A” and a series of nodes 431-435 labelled “Node B” through “Node F”, respectively. Control plane 420 includes a set of chain-of-events microservices that are used to establish the order and distribution of events between the compute nodes in distributed computer system 400. Each new request calls the microservices that are serialized in a unique order as they are processed through event queue 220 and spawned as Event Actors that are distributed across Kubernetes cluster 410. Thus, the system of receiving events and spawning and distributing Event Actors establishes the randomness that the Query Chain architecture exploits to provide additional security against attempts by bad actors.

For example, assume that an un-authorized attempt to access data is received by one of Nodes 431-435. The attempted access may reference data associated with an event actor, but the bad actor will not possess the correct chain-of-events to establish a proof-of-stake needed to access the data because this information is cryptographically known by authorized users but not known by bad actors. Thus, distributed computer system rejects the attempted access and foils the hack.

Moreover, the malicious access attempt can be rejected quickly without the need for the computationally intensive generation of block proofs needed by conventional blockchain architectures because each node operates as a digital twin to the blockchain blocks to alleviate the conventional blockchain mining latency. Thus, the Query Chain architecture with the chain-of-events consensus overcomes one of the core limitations of blockchain technology that has prevented more widespread adoption.

For purposes of explanation, numerous specific details are set forth to provide a thorough understanding of the description. It will be apparent, however, to one skilled in the art that implementations of the disclosure can be practiced without these specific details. In some instances, modules, structures, processes, features, and devices are shown in block diagram form to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure and performing certain actions.

The system as disclosed herein may include a plurality of individual components (e.g., computer devices) each programmed with at least some of the functions described herein. In this manner, some components of system may perform some functions while other components may perform other functions, as would be appreciated.

Reference to various features is described that may be preferences or requirements for some implementations, but not other implementations.

Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for processing transactions for a decentralized application of a computing system, comprising:
receiving a transaction having associated data by the computing system;
processing said transaction using an event actor architecture, wherein said processing comprises:
receiving a first block related to said transaction, wherein said first block includes a cryptographic signature;
cryptographically processing said transaction using a chain-of-events blockchain, wherein said chain-of-events blockchain includes a ledger of blocks cryptographically linked by events; and
rejecting said transaction if said transaction accesses a second block not linked to said first block in a correct chain-of-events.

2. The method of claim 1, wherein receiving said first block related to said transaction comprises:
receiving a web request by the computing system over hypertext transfer protocol (HTTP); and
activating a plurality of event actor microservices by the computing system in response to said web request.

3. The method of claim 1, wherein processing said transaction using said event actor architecture comprises:
processing said transaction based on a Command Query Request Segregation (CQRS) design pattern.

4. The method of claim 1, wherein processing said transaction using said event actor architecture further comprises:
adding a new transaction to an existing Merkle Tree; and
distributing an event between newly-created child events and its parent Merkle Tree.

5. The method of claim 1, wherein processing said transaction using said event actor architecture further comprises:
cryptographically linking said first block to said chain-of-events blockchain if said transaction only accesses blocks linked to said first block in a correct chain-of-events.

6. The method of claim 1, wherein processing said transaction using said event actor architecture further comprises:
receiving an event of a new transaction; and
updating a root hash key of a corresponding parent Merkle Tree without broadcasting an updated root hash key to any other sibling event actors.

7. The method of claim 1, wherein processing said transaction using said event actor architecture further comprises:
receiving a block related to said transaction over an Envoy ingress controller with rate limit and whitelisted internet protocol (IP) addresses using an OpenAPI RESTful request; and
activating event actor microservices in response to said OpenAPI RESTful request.

8. The method of claim 1, wherein said computing system comprises a Google Kubernetes cluster.

9. The method of claim 8, further comprising:
horizontally scaling services by extending a number of nodes of said Google Kubernetes cluster.

10. A method for creating and maintaining a blockchain having a ledger having a set of cryptographically linked blocks, comprising:
receiving a transaction having associated data;
generating block proofs for said transaction;
linking a first block having said associated data and said block proofs to one of said set of cryptographically linked blocks;
forming a Merkle tree that maintains proofs for each block in the ledger;
receiving a communication request by said first block; and
if the communication request accesses a second block not linked to said first block in a correct chain-of-events, rejecting said communication request.

11. The method of claim 10, further comprising:
receiving an incoming request;
translating said incoming request into one or more events; and
distributing said one or more events over a processing cluster of a computing system.

12. The method of claim 11, wherein said distributing comprises:
streaming said incoming request as an array of binary bytes transmitted according to representational state transfer (REST) protocol.

13. The method of claim 11, wherein said processing cluster comprises a Google Kubernetes processing cluster.

14. The method of claim 11, wherein each event actor has an associated private key, and said linking comprises:
persisting said associated private key of said first block and a hash key of a parent Merkle tree by said event actor; and
as a new transaction is added to said parent Merkle Tree, distributing a corresponding event between a newly created child event and said parent Merkle Tree.

15. The method of claim 11, further comprising:
streaming a series of incoming requests into a corresponding series of events, and for each incoming request:
distributing said corresponding series of events over said processing cluster;
linking each event of said corresponding series of events to corresponding prior events of the blockchain; and
updating said Merkle tree to generate a new combined hash.

16. The method of claim 15, wherein said streaming comprises:
streaming said corresponding series of events through an event queue of an event actor broker; and
routing each event to a corresponding receiver.

17. A computing system for creating and maintaining a blockchain having a ledger having a set of cryptographically linked blocks, comprising:
a plurality of computing nodes, each capable of processing event actors;
a control plane coupled to and providing microservices to each of said plurality of computing nodes and wherein in response to receiving a transaction having associated data by the computing system, said control plane interacts with said plurality of computing nodes to process said transaction using an event actor architecture by:
receiving a first block related to said transaction, wherein said first block includes a cryptographic signature;
cryptographically processing said transaction using a chain-of-events blockchain, wherein said chain-of-events blockchain includes a ledger of blocks cryptographically linked by events; and
rejecting said transaction if said transaction accesses a second block not linked to said first block in a correct chain-of-events.

18. The computing system of claim 17, wherein said control plane:
activates a plurality of event actor microservices by in response to receiving said transaction by the computing system over hypertext transfer protocol (HTTP).

19. The computing system of claim 17, wherein said control plane:
processes said transaction based on a Command Query Request Segregation (CQRS) design pattern.

20. The computing system of claim 17, wherein said control plane:
adds a new transaction to an existing Merkle Tree; and
distributes an event between newly-created child events and its parent Merkle Tree.

21. The computing system of claim 17, wherein said control plane processes said transaction using said event actor architecture by:
cryptographically linking said first block to said chain-of-events blockchain if said transaction only accesses blocks linked to said first block in a correct chain-of-events.

22. The computing system of claim 17, wherein said control plane processes said transaction using said event actor architecture by:
receiving an event of a new transaction; and
updating a root hash key of a corresponding parent Merkle Tree without broadcasting an updated root hash key to any other sibling event actors.

23. The computing system of claim 17, wherein said control plane processes said transaction using said event actor architecture by:
receiving a block related to said transaction over an Envoy ingress controller with rate limit and whitelisted internet protocol (IP) addresses using an OpenAPI RESTful request; and
activating event actor microservices in response to said OpenAPI RESTful request.

24. The computing system of claim 17, wherein said computing system comprises a Google Kubernetes cluster.

25. The computing system of claim 24, wherein said control plane processes said transaction using said event actor architecture by:
horizontally scaling services by extending a number of nodes of said Google Kubernetes cluster.
